(19) United States
(12) Patent Application Publication
(10) Pub. No.: US 2006/0225974 A1
(43) Pub. Date: Oct. 12, 2006

(54) Brake spider and axle housing assembly

(75) Inventors: Jorge Inada, Troy, MI (US); Joseph L. Malkowski, Troy, MI (US); Joseph A. Kay, Highland, MI (US); Roy Lee Hayford, Canton, MI (US); Thomas M. Cory, Sterling Heights, MI (US)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Technology, LLC

(21) Appl. No.: 11/101,282

(22) Filed: Apr. 7, 2005

(51) Int. Cl. F16D 65/14

(52) U.S. Cl. 188/206 A

(57) ABSTRACT

A brake spider includes a spider body with a central opening and a slot for receiving a camshaft and bracket assembly. The brake spider is attached to an axle housing via the central opening. The slot is defined by an inner surface that does not completely surround the camshaft. The slot allows the camshaft and bracket assembly to be removed from a wheel end assembly for service operations without having to remove other components from the wheel end assembly, such as a wheel hub, for example.

### TECHNICAL FIELD

The subject invention relates to a wheel end and axle assembly having an integrated brake spider where a camshaft and bracket assembly is removable from the wheel end and axle assembly without requiring removal of a wheel hub.

### BACKGROUND OF THE INVENTION

Wheel end assemblies are supported on opposing ends of a vehicle axle. The vehicle axle includes an axle housing that extends between the wheel end assemblies. Each wheel end assembly includes a brake assembly and a wheel hub supported on bearings for rotation relative to the axle housing. The brake assembly includes a brake drum that is mounted for rotation with the wheel hub and a brake spider that mounts non-rotating brake components to the axle housing.

Non-rotating brake components include brake shoes that are pivotally supported by anchor pins at one shoe end, and which are actuated by a camshaft at an opposite shoe end. The camshaft rotates to move the brake shoes into engagement with the brake drum to slow or stop a vehicle.

The brake spider includes a spider body having a central opening surrounded by a plurality of radially spaced apertures extending through the spider body. The brake spider is slid over one end of the axle housing through the central opening of the spider body. The brake spider is fastened to an axle housing flange with a plurality of fasteners that extend through the plurality of radially spaced apertures.

One portion of the spider body has a single circular opening for receiving the camshaft and another portion of the spider body includes a pair of circular openings for receiving the anchor pins. A camshaft bushing is installed within the single circular opening to rotatably support the camshaft. One end of the camshaft is slid through the camshaft bushing such that the cam is positioned to actuate the brake shoes. An opposite end of the camshaft is coupled to a brake actuator.

In order to service the camshaft, the brake drum and the wheel hub must both be removed from the vehicle axle. This is time consuming and expensive. Additionally, removing the wheel hub from the vehicle axle can adversely affect seal and bearing assemblies. This can lead to premature wear for various wheel end components.

Thus, there is a need for a wheel end configuration that allows removal of the camshaft for service operations without requiring removal of the wheel hub and/or brake drum.

### SUMMARY OF THE INVENTION

A brake spider includes a spider body having a central opening that surrounds an axle housing. A slot is formed within the spider body to receive a camshaft and a camshaft bracket assembly. The slot is defined by a surface that does not completely surround the camshaft. The slot allows the camshaft to be removed from a wheel end without requiring removal of other wheel end components.

In one example, a wheel hub is mounted for rotation relative to the axle housing about a wheel axis of rotation. A brake drum is mounted for rotation with the wheel hub about the wheel axis of rotation. The brake drum defines a cavity in which the brake spider is mounted. The camshaft rotates about a camshaft axis of rotation to actuate a brake component, such as brake shoes for example, in response to a braking command. By positioning the camshaft and the camshaft bracket assembly within the slot of the brake spider, the camshaft and the camshaft bracket assembly can be removed for service as needed without having to remove the wheel hub.

The slot is defined by an inner surface that is discontinuous about the camshaft axis of rotation. In the example shown, the camshaft axis of rotation is parallel to and spaced apart from the wheel axis of rotation. The wheel axis of rotation defines a lateral direction and the camshaft is removable from the slot by moving the camshaft along a linear path that extends along a longitudinal direction.

The subject invention provides a simplified method and apparatus for removing a camshaft from a wheel end assembly that does not require a wheel hub to be removed. This reduces cost and labor, as well as reducing the potential for premature wear or damage to other wheel end components. These and other features of the present invention can be best understood from the following specification and drawings, the following of which is a brief description.

### BRIEF DESCRIPTION OF THE DRAWINGS

FIG. 1 is a perspective view of an axle housing and brake spider assembly incorporating the subject invention.

FIG. 2 is a cross-sectional view of a wheel end assembly incorporating the subject invention.

FIG. 3 is a cross-sectional view of another embodiment of a wheel end assembly incorporating the subject invention.

### DETAILED DESCRIPTION OF THE PREFERRED EMBODIMENT

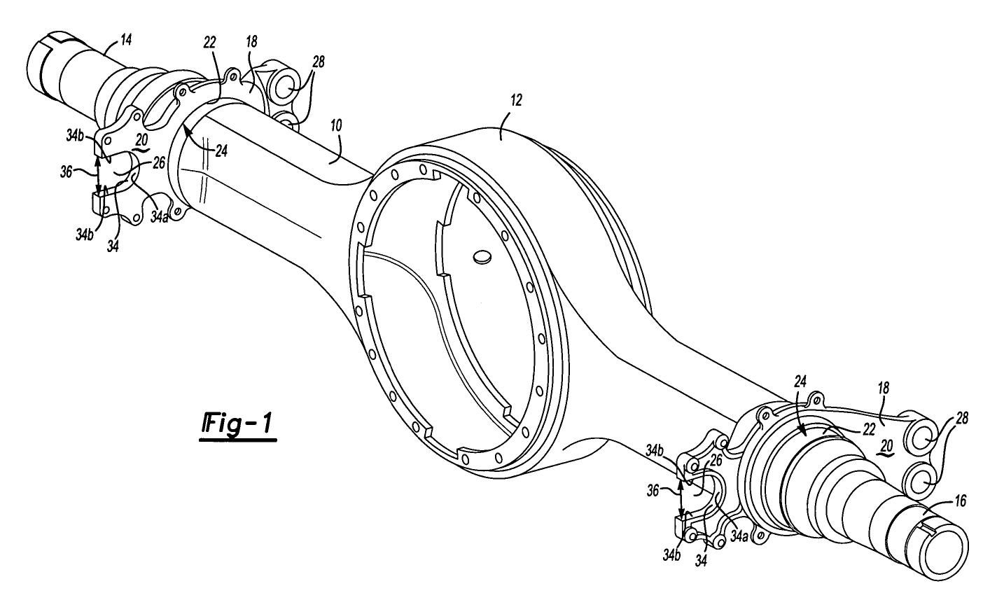

An axle housing 10 is shown in FIG. 1. The axle housing 10 includes a center portion 12 that is positioned between first 14 and second 16 axle ends. A unique brake spider 18 is mounted to each of the first 14 and second 16 axle ends or is mounted to leg portions of the axle housing 10. The brake spider 18 is preferably attached by welding, however, other attachment methods could also be used.

The brake spider 18 is configured to provide advantages for assembling and disassembling components to and from the axle housing 10 when compared to prior spider configurations. In the example shown, the axle housing 10 comprises a drive axle housing, however, it should be understood that any type of axle could utilize the brake spider 18.

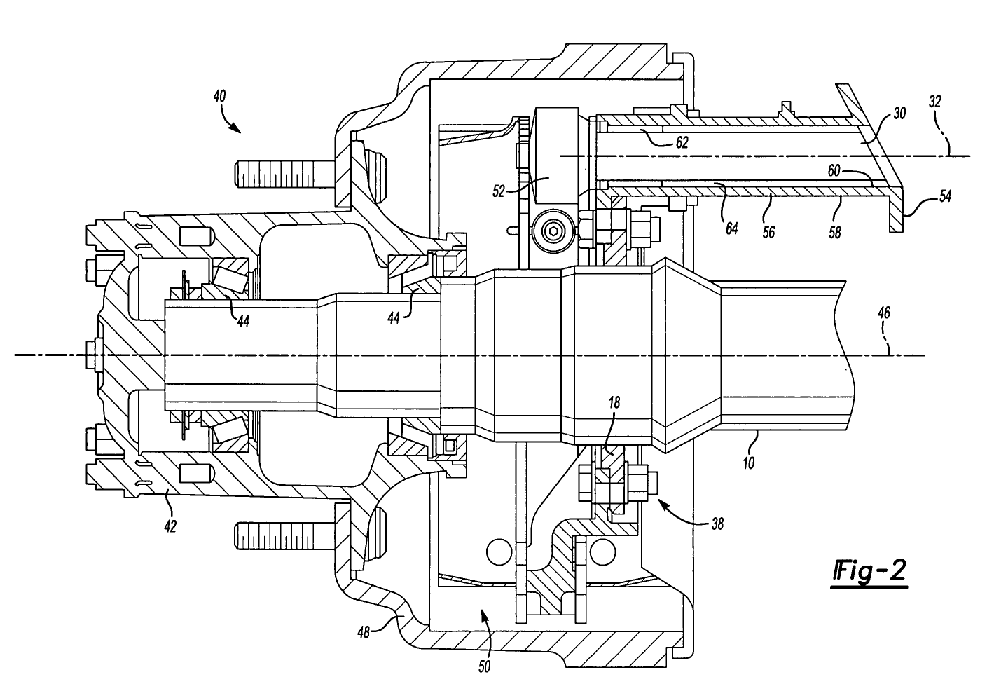

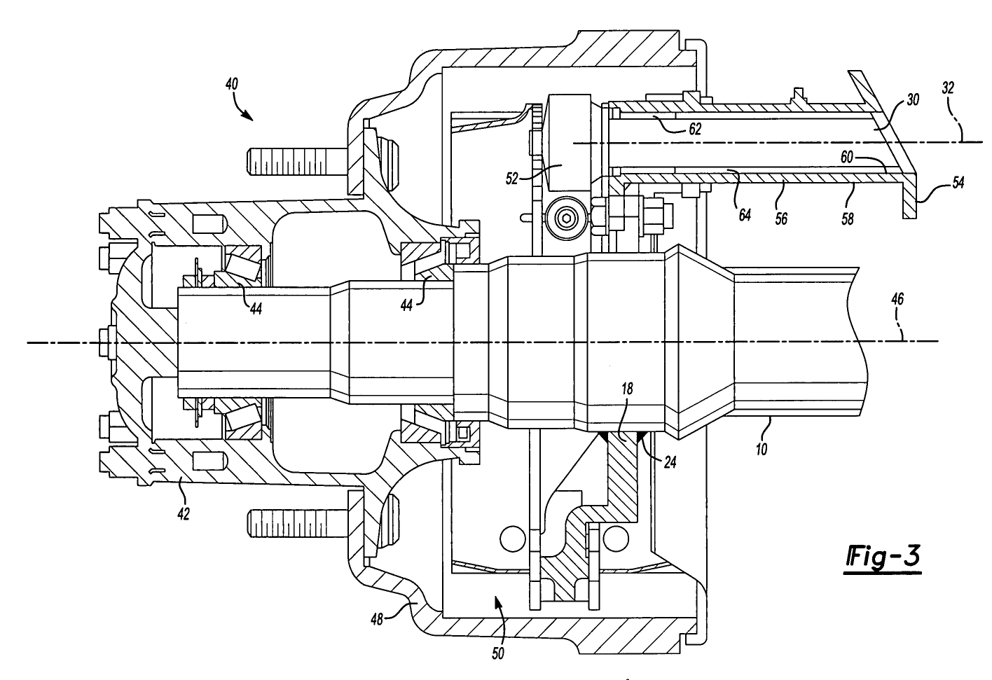

The brake spider 18 includes a spider body 20 with a center opening 22. The center opening 22 surrounds the axle housing 10. Preferably, the spider body 20 is welded at 24 (see FIG. 3) to the axle housing 10 about the center opening 22. The spider body 20 includes a slot 26 on one side of the center opening 22 and a pair of circular openings 28 on an opposite side of the center opening 22. The slot 26 is adapted to receive a camshaft 30 that rotates about a camshaft axis 32 (FIGS. 2 and 3). The pair of circular openings 28 is adapted to receive anchor pins (not shown) that pivotally support brake shoes (not shown) as is known in the art. The camshaft 30 actuates the brake shoes to provide wheel braking in response to a braking command as known.

The slot 26 is defined by an inner surface 34 that is discontinuous about the camshaft axis 32. The inner surface 34 extends less than three hundred and sixty degrees about the camshaft axis 32. In other words, when the camshaft 30 is received within the slot 26, the inner surface 34 does not completely surround the camshaft 30. The slot 26 is thus open to external surroundings at a gap 36, which allows the camshaft 30 to be easily moved into and out of the slot 26.

In the example shown, the inner surface 34 is defined as a U-shaped surface having a bottom surface portion 34a extending inwardly toward a center of the spider body 20 and a pair of leg surface portions 34b. The pair of leg surface portions 34b extend outwardly away from the center of the spider body 20. Distal ends of each leg surface portion 34b are spaced apart from each other to define the gap 36.

The brake spider 18 is installed within a wheel end assembly, shown generally at 40 in FIG. 2. In this embodiment, the brake spider 18 is attached to a flange portion of axle housing 10 at bolted joint 38, however this is just one example of an attachment interface. Another example of an attachment interface is shown in FIG. 3. In this example, brake spider 18 is welded at 24 to axle housing 10.

In either configuration, a wheel hub 42 is supported on bearings 44 for rotation relative to the axle housing 10 about a wheel axis 46. A brake drum 48 is mounted for rotation with the wheel hub 42 about the wheel axis 46. The brake drum 48 defines a cavity 50 that receives a brake assembly that includes the brake spider 18.

The camshaft 30 includes a cam 52 at one end and is coupled to a brake actuator (not shown) at an opposite end. In response to a braking command, the brake actuator rotates the camshaft 30 about the camshaft axis 32 to cause the cam 52 to move the brake shoes into engagement with the brake drum 48.

A camshaft bracket 54 connects the camshaft 30 to the brake spider 18. The camshaft bracket 54 is shown as being bolted to the brake spider 18 in FIG. 2, however, it should be understood that other connection methods could be used to connect the camshaft bracket 54 to the brake spider 18 including welding, for example. The camshaft bracket 54 includes a tubular portion 56 that has an exterior surface 58 and an interior surface 60. A camshaft bushing 62 is received within the tubular portion 56 to engage the interior surface 60. The camshaft 30 is supported within the camshaft bushing 62 for rotation about the camshaft axis 32. The tubular portion 56 is received within the brake spider 18 such that the slot 26 (FIG. 1) surrounds a portion of the exterior surface 58 of the tubular portion 56. A clearance 64 is maintained between the camshaft 30 and the interior surface 60 of the tubular portion 56 to allow the camshaft 30 to rotate relative to the camshaft bracket 54.

The slot 26 allows the camshaft 30 to be removed from the wheel end assembly 40 without requiring removal of the wheel hub 42 from the wheel end assembly 40. This facilitates service and maintenance operations. With traditional spider configurations, the wheel hub 42 had to be removed from the wheel end assembly 40 before the camshaft 30 could be removed. This was labor intensive and resulted in significant cost and vehicle downtime.

In the example shown, the wheel axis 46 and the camshaft axis 32 are spaced apart from each other and are generally parallel to each other. The wheel axis 46 and the camshaft axis 32 define a lateral direction. The slot 26 allows the camshaft 30 to move relative to the brake spider 18 along a linear path that is generally transverse to the lateral direction. This linear path extends generally in a longitudinal direction. To remove the camshaft 30 from the brake spider 18, the camshaft 30 is moved longitudinally out of the slot 26, and is then removed from the wheel hub 42. Thus, the wheel hub 42 remains mounted to the axle housing 10 during service or maintenance operations for the camshaft 30.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A brake spider comprising:
a spider body; and
a slot formed within said spider body, said slot being adapted to receive a camshaft for rotation about a camshaft axis wherein said slot is defined by an inner surface that is discontinuous about the camshaft axis.

2. The brake spider according to claim 1 wherein said inner surface extends less than three hundred and sixty degrees about the camshaft axis.

3. The brake spider according to claim 1 wherein said inner surface comprises a U-shaped surface having a bottom surface portion extending inwardly toward a center of said spider body and a pair of leg surface portions extending outwardly away from the center of said spider body.

4. The brake spider according to claim 1 wherein said spider body includes a center opening adapted to receive a non-rotating axle component and a pair of anchor pin openings that are positioned on an opposite side of said spider body from said slot.

5. A wheel end assembly comprising:
a wheel hub mounted for rotation relative to an axle housing about a wheel axis of rotation;
a brake drum mounted for rotation with said wheel hub about said wheel axis of rotation;
a brake spider adapted to be supported by the axle housing, said brake spider including a spider body having a slot; and
a camshaft received within said slot wherein said camshaft is removable from the brake spider and the wheel end assembly without removing said wheel hub from the wheel end assembly.

6. The wheel end assembly according to claim 5 wherein said slot is defined by an inner surface that partially surrounds said camshaft.

7. The wheel end assembly according to claim 5 wherein said camshaft defines a camshaft axis of rotation that is spaced apart from said wheel axis of rotation and wherein said slot is defined by an inner surface that is discontinuous about said camshaft axis of rotation.

8. The wheel end assembly according to claim 5 wherein said camshaft is movable within said slot in a first axial direction that is transverse to a second axial direction defined by said wheel axis of rotation.

9. The wheel end assembly according to claim 8 wherein said first axial direction is a longitudinal direction and wherein said second axial direction is a lateral direction.

10. The wheel end assembly according to claim 5 wherein said spider body includes a center opening that completely surrounds the axle housing and a pair of anchor pin openings that are positioned on an opposite side of said spider body from said slot.

11. The wheel end assembly according to claim 10 wherein said brake spider is welded to the axle housing about the center opening of the spider body.

12. The wheel end assembly according to claim 5 including a camshaft bracket having a tubular portion defined by an exterior surface and an interior surface wherein said camshaft is received within said tubular portion such that said slot surrounds a portion of said exterior surface.

13. The wheel end assembly according to claim 12 including a camshaft bushing received with said tubular portion and engaging said interior surface wherein said camshaft is rotatably supported in said camshaft bushing for rotation relative to said camshaft bracket.

14. A method for assembling and disassembling a wheel end assembly comprising the steps of:
(a) supporting a brake spider having a slot on an axle housing;
(b) supporting a wheel hub for rotation relative to the axle housing about a wheel axis of rotation;
(c) positioning a camshaft within the slot of the brake spider for rotation about a camshaft axis of rotation that is spaced apart from the wheel axis of rotation; and
(d) removing the camshaft from the brake spider as needed for service without removing the wheel hub from the wheel end assembly.

15. The method of claim 14 wherein the wheel axis of rotation defines a lateral direction and wherein step (d) includes moving the camshaft in a longitudinal direction.

16. The method of claim 14 wherein step (d) includes moving the camshaft out of the slot along a linear path that is transverse to the camshaft axis of rotation.

17. The method of claim 14 including the steps of mounting a brake drum for rotation with the wheel hub about the wheel axis of rotation, positioning the brake spider within a cavity defined by the brake drum, and positioning the camshaft within the slot such that the camshaft is adapted to actuate a brake component for engagement with the brake drum in response to a braking command.

18. The method of claim 14 including the steps of defining the slot with an inner surface that extends less than three hundred and sixty degrees about the camshaft axis of rotation.

19. The method of claim 14 including supporting the camshaft with a bracket assembly and wherein step (c) includes positioning the camshaft and the bracket assembly within the slot, and step (d) includes removing the camshaft and the bracket assembly from the brake spider without removing the wheel hub from the wheel end assembly.
